(19) United States
(12) Patent Application Publication
(10) Pub. No.: US 2013/0062953 A1
(43) Pub. Date: Mar. 14, 2013

(54) Reconfigurable Power Converters, Systems and Plants

(71) Applicants: Jukka Nurmi, Vantaa (FI); Hongrae Kim, Cary, NC (US); Waqas Arshad, Raleigh, NC (US)

(72) Inventors: Jukka Nurmi, Vantaa (FI); Hongrae Kim, Cary, NC (US); Waqas Arshad, Raleigh, NC (US)

(73) Assignee: ABB RESEARCH LTD., Zurich (CH)

(21) Appl. No.: 13/417,435

(22) Filed: Mar. 12, 2012

Related U.S. Application Data
(60) Provisional application No. 61/476,021, filed on Apr. 15, 2011.

(51) Int. Cl. H02J 4/00

(52) U.S. Cl. 307/72

(57) ABSTRACT

Reconfigurable power systems, converters and plants are disclosed, along with operating methods therefor. Reconfigurable power systems may include a DC power source, an electrical energy storage device, an AC power grid connection, a first power converter, and a second power converter. The first power converter may be configured to selectively couple two or more of the DC power source, the electrical energy storage device, and the AC power grid connection. The second power converter may be configured to selectively couple the electrical energy storage device to at least one of the DC power source and the first power converter. The second power converter may be configured as a DC-DC converter.

### CROSS REFERENCE TO RELATED APPLICATION(S)

This application claims the benefit of and priority to U.S. Provisional Patent Application Ser. No. 61/476,021, which was filed on Apr. 15, 2011 and is entitled “Reconfigurable Power Converters, Systems and Plants.” The complete disclosure of the above-identified patent application is hereby incorporated by reference for all purposes.

### FIELD OF THE DISCLOSURE

The present disclosure relates to power converters and systems, and more particularly to reconfigurable power converters and systems.

### BACKGROUND

Examples of solar and electric power converter systems are disclosed in U.S. Pat. Nos. 7,072,194; 6,914,418 and 6,590,793 and in U.S. Patent Application Publication No. 2010/0008119. Examples of battery charging using solar or photovoltaic panels and maximum power point tracking (MPPT) are disclosed in U.S. Pat. Nos. 7,834,580; 6,914,418 and 6,057,665. The disclosures of these and all other publications referenced herein are incorporated by reference in their entirety for all purposes.

### SUMMARY

In some examples, reconfigurable power systems may include a DC power source, an electrical energy storage device, an AC power grid connection, a first power converter, and a second power converter. The first power converter may be configured to selectively couple two or more of the DC power source, the electrical energy storage device, and the AC power grid connection. The second power converter may be configured to selectively couple the electrical energy storage device to at least one of the DC power source and the first power converter. The second power converter may be configured as a DC-DC converter.

In some examples, reconfigurable power converters may include a power source connection configured to couple with a DC power source, a storage device connection configured to couple with an electrical energy storage device, a grid connection configured to couple with an AC power grid, a first power converter, and a second power converter. The first power converter may be configured to selectively couple two or more of the power source connection, the storage device connection, and the grid connection. The first power converter may be configured as a DC-DC converter when coupling the power source connection to the storage device connection, a DC-AC inverter when coupling at least one of the power source connection and the storage device connection to the grid connection, and an AC-DC converter when coupling the grid connection to the storage device connection. The second power converter may be configured to selectively couple the storage device connection to at least one of the power source connection and the first power converter. The second power converter may be configured as a DC-DC converter.

In some examples, methods of operating reconfigurable power systems that include a DC power source, an electrical energy storage device, and an AC power grid connection, may include configuring a first power converter as a DC-DC converter and coupling the DC power source to the electrical energy storage device therewith, configuring the first power converter as a DC-AC inverter and coupling the DC power source to the AC power grid connection therewith while a second power converter, which may be configured as a DC-DC converter, couples the electrical energy storage device to the DC power source and the first power converter, and configuring the first power converter as a DC-AC inverter and coupling the electrical energy storage device to the AC power grid connection therewith.

### BRIEF DESCRIPTION OF DRAWINGS

FIG. 1 is a block diagram of a nonexclusive illustrative example of a reconfigurable power system.

FIG. 2 is a block diagram of a nonexclusive illustrative example of a reconfigurable power converter.

FIG. 3 is a schematic diagram of a nonexclusive illustrative example of a 3-phase asymmetric reconfigurable power system.

FIG. 4 is a schematic diagram of a nonexclusive illustrative example of a 3-phase symmetric reconfigurable power system.

FIG. 5 is a schematic diagram of a nonexclusive illustrative example of a single-phase asymmetric reconfigurable power system.

FIG. 6 is a schematic diagram of a nonexclusive illustrative example of a single-phase symmetric reconfigurable power system.

FIG. 7 is a schematic diagram of another nonexclusive illustrative example of a 3-phase asymmetric reconfigurable power system, shown with a first power converter connecting a photovoltaic DC power source to an electrical energy storage device.

FIG. 8 is a schematic diagram of the reconfigurable power system of FIG. 7, shown with the photovoltaic DC power source connected to the AC power grid by the first power converter and to the electrical energy storage device by a second power converter.

FIG. 9 is a schematic diagram of the reconfigurable power system of FIG. 7, shown with the first power converter connecting the photovoltaic DC power source to the AC power grid.

FIG. 10 is a schematic diagram of the reconfigurable power system of FIG. 7, shown with the photovoltaic DC power source connected to the AC power grid by the first power converter and the electrical energy storage device connected to the first power converter, and the AC power grid, by the second power converter.

FIG. 11 is a schematic diagram of the reconfigurable power system of FIG. 7, shown with the first power converter connecting the electrical energy storage device to the AC power grid.

FIG. 12 is a schematic diagram of the reconfigurable power system of FIG. 7, shown with the first power converter connecting the AC power grid to the electrical energy storage device.

FIG. 13 is a daily timeline illustrating a nonexclusive illustrative implementation example, which may be suitable for one of the reconfigurable power systems and/or converters disclosed herein.

FIG. 14 is a schematic diagram of another nonexclusive illustrative example of a 3-phase symmetric reconfigurable power system.

FIG. 15 is a schematic diagram of a nonexclusive illustrative example of a power plant that includes a plurality of reconfigurable power systems, such as the reconfigurable power system of FIG. 7.

### DETAILED DESCRIPTION

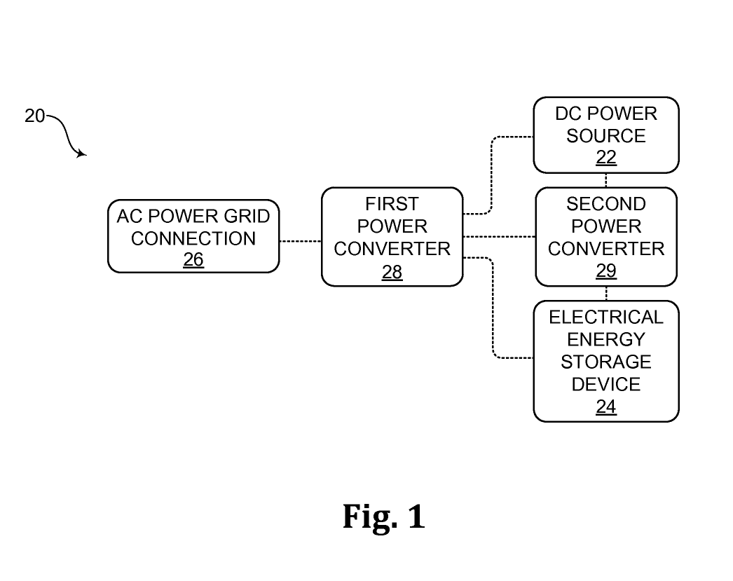

A nonexclusive illustrative example of a reconfigurable power system is shown generally at 20 in FIG. 1. Unless otherwise specified, the reconfigurable power system 20 may, but is not required to, contain at least one of the structures, components, functionalities, and/or variations described, illustrated, and/or incorporated herein. In the illustrated example, the power system 20 includes a DC power source 22, an electrical energy storage device 24, a connection to an AC power grid or AC power grid connection 26, a first power converter 28, and an auxiliary or second power converter 29.

The DC power source 22 may include any DC source, such as an intermittent or non-base load source. For example, the DC power source may include at least one solar or photovoltaic (PV) cell. In some examples, at least a portion of the DC source may include other intermittent power sources such as wind or tidal power. However, some possible intermittent power sources, such as wind and tidal power, may need to be converted to DC before use with the reconfigurable power system 20.

The electrical energy storage device 24 may include any suitable combination of devices or structures capable of storing electrical energy. Nonexclusive illustrative examples of such devices include, without limitation, electrochemical cells or batteries, capacitors, supercapacitors, flywheels, or the like.

The first power converter 28 may be configured to selectively couple two or more of the DC power source 22, the electrical energy storage device 24, the AC power grid connection 26, and the second power converter 29.

The second power converter 29 may be configured to selectively couple the electrical energy storage device 24 to at least one of the DC power source 22 and the first power converter 28. The second power converter 29 may be configured as a DC-DC converter. As will be more fully set out below, the second power converter 29 may be used in some examples where the electrical energy storage device 24 is being charged and/or discharged.

Either or both of the first power converter 28 and the second power converter 29 may include at least one switching element or device. The switching element or device may include at least one semiconductor switching device, such as a power transistor, a power MOSFET, an insulated gate bipolar transistor (IGBT), a gate turn-off thyristor (GTO), or the like. By changing the on-off duty ratio and frequency of the switching element or device, the first power converter 28 and/or the second power converter 29 can control its output voltage and frequency.

The first power converter 28 may be configured to operate in a selected one of at least three modes. For example, the first power converter 28 may be configured to selectively operate or function as a DC-AC inverter, a DC-DC converter, or an AC-DC converter. The first power converter 28 may be configured to function as a DC-AC inverter when coupling the DC power source 22 and/or the electrical energy storage device 24 to the AC power grid connection 26, such as to deliver power from the DC power source, the electrical energy storage device, or both to the AC power grid. When the first power converter 28 is configured as a DC-AC inverter that couples the DC power source 22 and the electrical energy storage device 24 to the AC power grid connection 26, the electrical energy storage device may be coupled to the DC power source and to the first power converter by way of the second power converter 29. The first power converter 28 may be configured to function as a DC-DC converter when coupling the DC power source 22 to the electrical energy storage device 24, such as to charge the electrical energy storage device. The first power converter 28 may be configured to function as an AC-DC converter when coupling the AC power grid connection 26 to the electrical energy storage device 24, such as to charge the electrical energy storage device from the AC power grid.

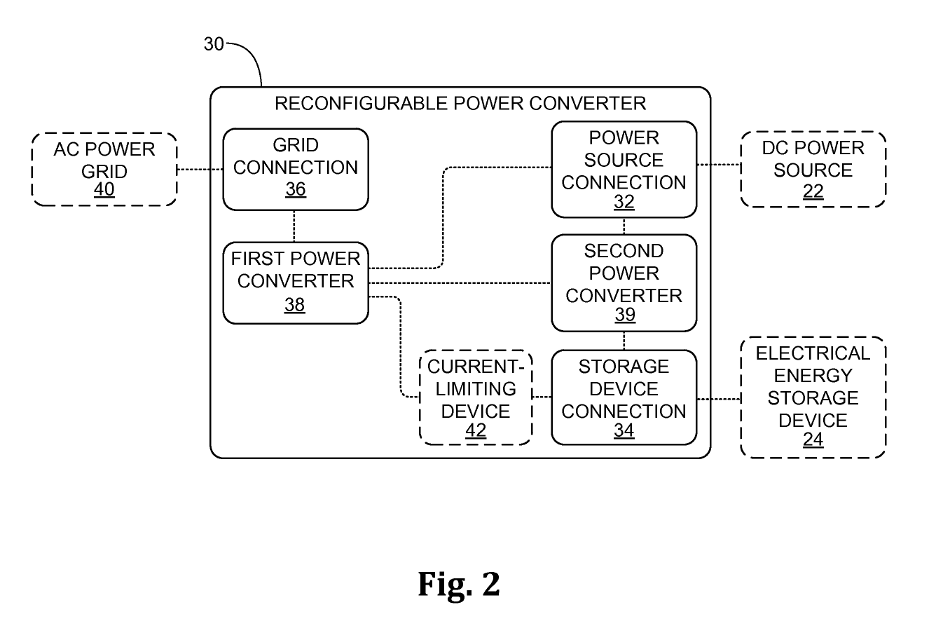

A nonexclusive illustrative example of a reconfigurable power converter is shown generally at 30 in FIG. 2. Unless otherwise specified, the reconfigurable power converter 30 may, but is not required to, contain at least one of the structures, components, functionalities, and/or variations described, illustrated, and/or incorporated herein. In the illustrated example, the reconfigurable power converter 30 includes a power source connection 32, a storage device connection 34, a grid connection 36, a first power converter 38, and an auxiliary or second power converter 39. The power source connection 32 may be configured to couple with a DC power source 22, the storage device connection 34 may be configured to couple with an electrical energy storage device 24, and the grid connection 36 may be configured to couple with an AC power grid 40.

The first power converter 38, which may include at least one semiconductor switching device, may be configured to selectively couple two or more of the power source connection 32, the storage device connection 34, the grid connection 36, and the second power converter 39. The first power converter 38 may be selectively configured as, for example, a DC-DC converter, a DC-AC inverter or an AC-DC converter. For example, when coupling the power source connection 32 to the storage device connection 34, the first power converter 38 may be configured as a DC-DC converter. When coupling the grid connection 36 to at least one of the power source connection 32, the storage device connection 34 and the second power converter 39, the first power converter 38 may be configured as a DC-AC inverter. When coupling the grid connection 36 to the storage device connection 34, the power converter may be configured as an AC-DC converter.

The second power converter 39, which may be configured as a DC-DC converter and may include at least one semiconductor switching device, may be configured to selectively couple the storage device connection 34 to at least one of the power source connection 32 and the first power converter 38.

In some examples, the reconfigurable power converter 30 may include a current-limiting structure or device 42, such as a resistor. The current-limiting structure or device 42 may be configured to selectively limit inrush current to an electrical energy storage device 24 that is coupled with the storage device connection 34.

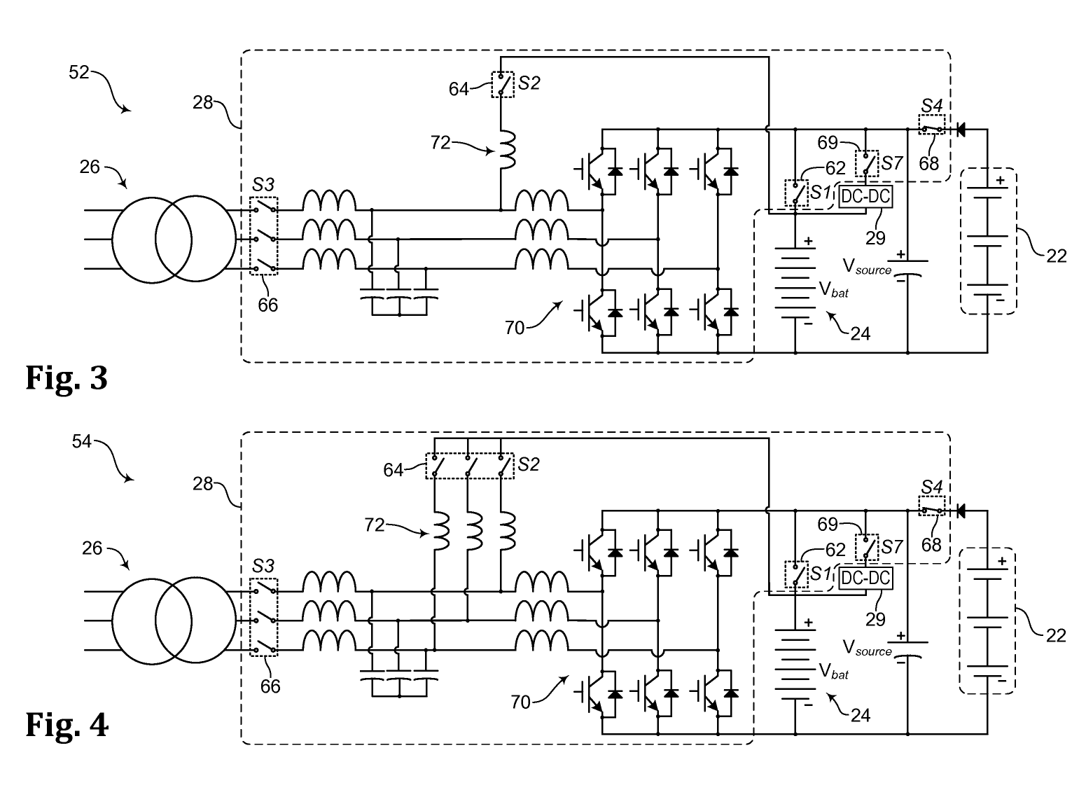

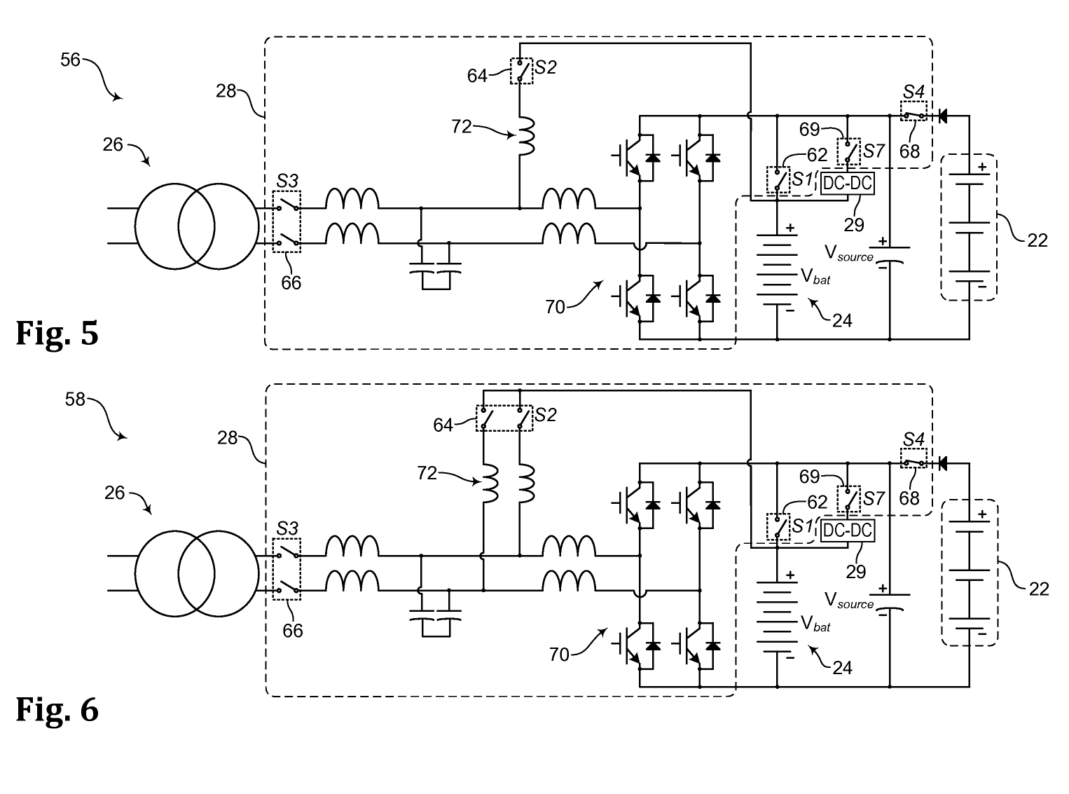

FIGS. 3-6 illustrate further nonexclusive illustrative examples of reconfigurable power systems. A 3-phase asymmetric reconfigurable power system 52 is shown in FIG. 3, a 3-phase symmetric reconfigurable power system 54 is shown in FIG. 4, a single-phase asymmetric reconfigurable power system 56 is shown in FIG. 5, and a single-phase symmetric reconfigurable power system 58 is shown in FIG. 6. Unless otherwise specified, the reconfigurable power systems 52, 54, 56, 58 may, but are not required to, contain at least one of the structures, components, functionalities, and/or variations described, illustrated, and/or incorporated herein. In the illustrated examples, each of the reconfigurable power systems 52, 54, 56, 58 includes a DC power source 22, an electrical energy storage device 24, an AC power grid connection 26, a first power converter 28 with a plurality of converter circuits 70, and a second power converter 29.

As shown in FIGS. 3-6, the power converters 28 of the reconfigurable power systems 52 may include a plurality of switches 62, 64, 66, 68, 69. In some examples, the power converters 28 may optionally include at least one inductor 72 on the circuit path used to charge the electrical energy storage device 24 from the DC power source 22, as will be set out below.

With regard to the asymmetric and symmetric configurations of the reconfigurable power systems 52, 54, 56, 58 of FIGS. 3-6, the asymmetric configuration may permit a reduction in manufacturing cost and/or physical size of the power converter. For example, the wiring would be simplified, the switch 64 would only need to include a single switch, and only a single inductor 72 would be needed. However, the symmetric configuration may permit more efficient utilization of the converter circuits 70 within the power converter and/or equalize the losses across all of the converter circuits 70, such as by equalizing the losses on the semiconductor switches in the power converter when using the DC power source to charge the battery, as will be set out below.

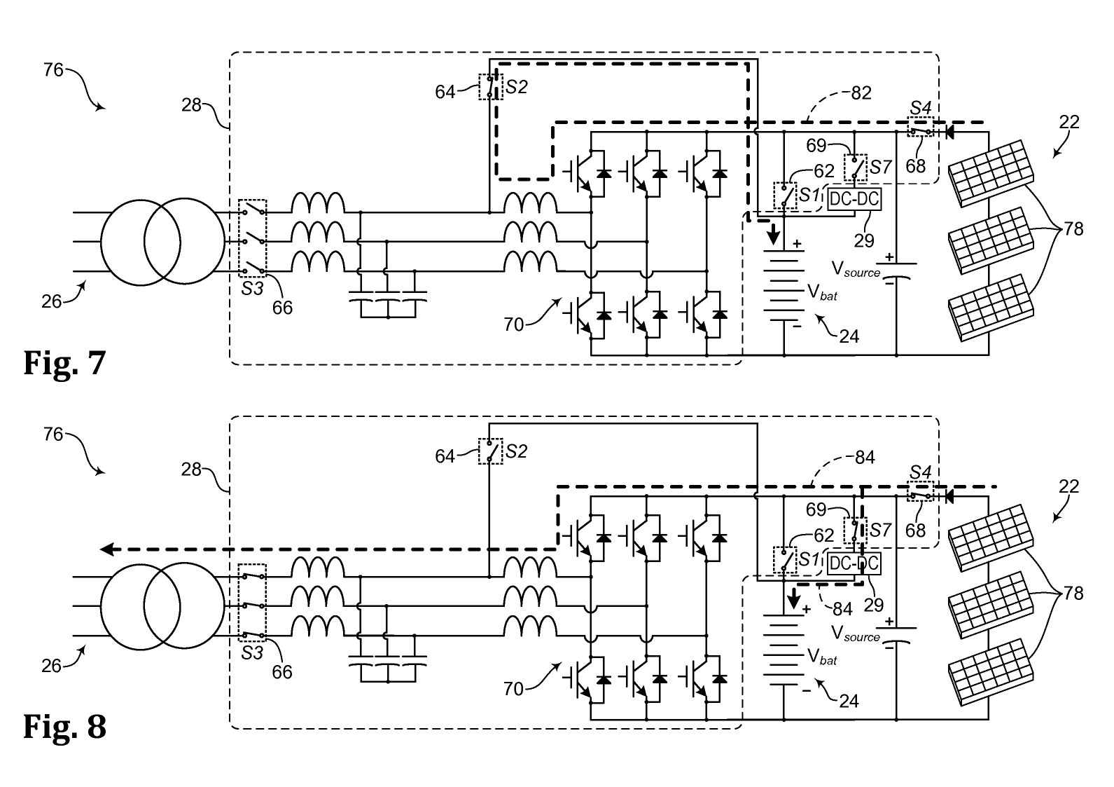

Another nonexclusive illustrative example of a reconfigurable power system is shown generally at 76 in FIGS. 7-12. Unless otherwise specified, the reconfigurable power system 76 may, but is not required to, contain at least one of the structures, components, functionalities, and/or variations described, illustrated, and/or incorporated herein. As shown, the reconfigurable power system 76 includes a DC power source 22, an electrical energy storage device 24, an AC power grid connection 26, a first power converter 28, and a second power converter 29. As shown in FIGS. 7-12, the DC power source 22 of the reconfigurable power system 76 may include a plurality of photovoltaic cells 78, and the electrical energy storage device 24 may include a battery.

The various operating modes or configurations of a reconfigurable power system and/or power converter may be explained more fully with reference to the reconfigurable power system 76, and its first and second power converters 28, 29, as illustrated in FIGS. 7-12.

In the mode illustrated in FIG. 7, the switches 64, 68 are closed, while the switches 62, 66, 69 are open, such that the first power converter 28 of the reconfigurable power system 76 is coupling the plurality of photovoltaic cells 78 of the DC power source 22 to the electrical energy storage device 24, with a power flow as generally suggested by the arrow 82. In this mode, the first power converter 28 is configured to function as a DC-DC converter such that the photovoltaic cells 78 charge the electrical energy storage device 24.

In some examples where the reconfigurable power system 76 is operating in the mode illustrated in FIG. 7, the first power converter 28 may perform maximum power point tracking (MPPT) with the photovoltaic cells 78. Under maximum power point tracking, the first power converter 28 attempts to function as a substantially optimal electrical load for the photovoltaic cells in order to extract a relatively high level of power from the photovoltaic cells. In some examples, the level of power extracted from the photovoltaic cells during maximum power point tracking may be near the maximum or even the maximum power available from the photovoltaic cells.

In the mode illustrated in FIG. 8, the switches 66, 68, 69 are closed, while the switches 62, 64 are open, such that the first power converter 28 of the reconfigurable power system 76 is coupling the plurality of photovoltaic cells 78 of the DC power source 22 to the electrical energy storage device 24 and to the AC power grid connection 26, with the electrical energy storage device 24 being coupled to the plurality of photovoltaic cells 78 and to the first power converter 28 by way of the second power converter 29. In this mode, the first power converter 28 is configured to function as a DC-AC inverter such that the photovoltaic cells 78 deliver power to the AC power grid through the first power converter 28 while charging the electrical energy storage device 24 through the second power converter 29, with a power flow as generally suggested by the arrows 84.

In some examples where the reconfigurable power system 76 is operating in the mode illustrated in FIG. 8, the first power converter 28 and/or the second power converter 29 may perform maximum power point tracking with the photovoltaic cells 78. The first power converter 28 is able to perform maximum power point tracking for the photovoltaic cells when the reconfigurable power system 76 is operating in the mode illustrated in FIG. 8 because coupling the electrical energy storage device 24 to the plurality of photovoltaic cells 78 by way of the second power converter 29 means that the voltage of the photovoltaic cells 78, vₚᵥ, need not be governed by the voltage of the electrical energy storage device 24, v_{bat}.

As may be understood, a relatively lower power may flow through the second power converter 29 to charge and/or discharge the electrical energy storage device 24 as compared to a rated power for the reconfigurable power system 76. Thus, for example, a second power converter 29 having a power rating that is only about 20% to about 30% of the rated power of the first power converter 28 and/or the reconfigurable power system 76 may be sufficient. Furthermore, inclusion of the second power converter 29 may permit more flexibility in selection and/or sizing of the electrical energy storage device 24 because Inclusion of the second power converter 29 may allow for avoiding operational modes in which the voltage of the photovoltaic cells 78, vₚᵥ, is governed by the voltage of the electrical energy storage device 24, v_{bat}.

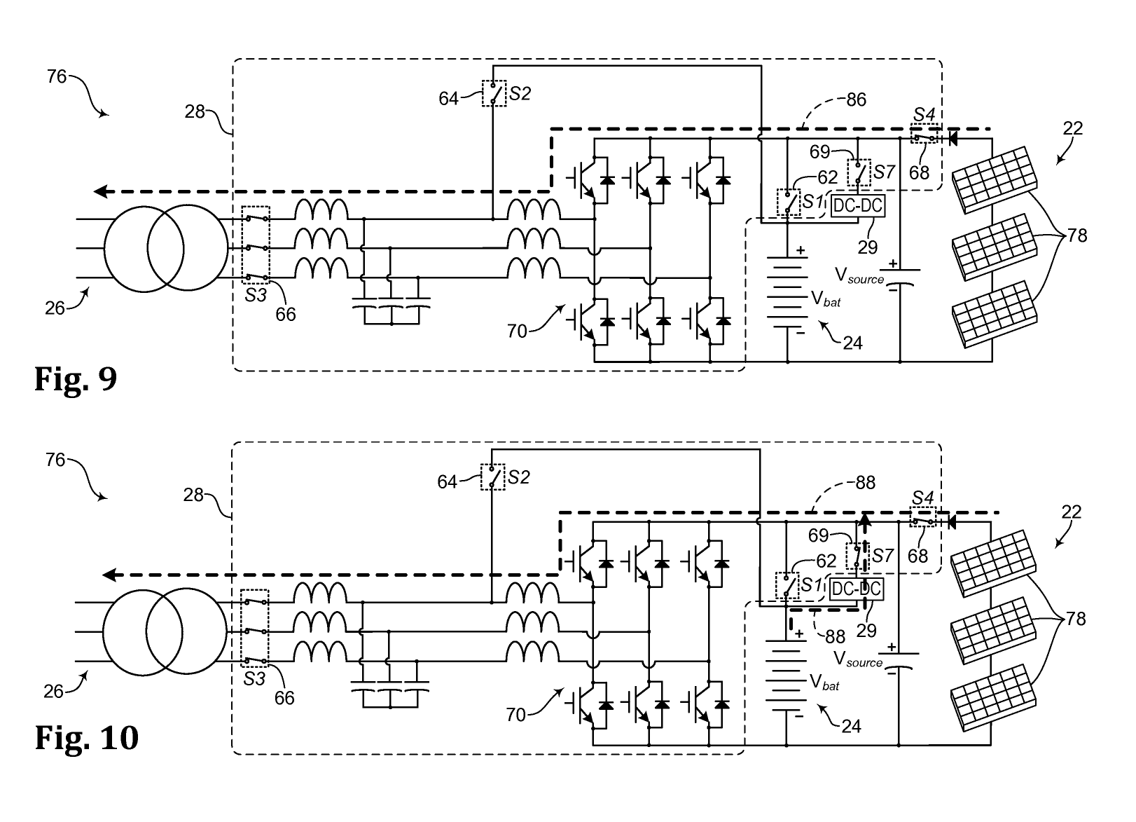

In the mode illustrated in FIG. 9, the switches 66, 68 are closed, while the switches 62, 64, 69 are open, such that the first power converter 28 of the reconfigurable power system 76 is coupling the plurality of photovoltaic cells 78 to the AC power grid connection 26. In this mode, the first power converter 28 is configured to function as a DC-AC inverter such that the photovoltaic cells 78 deliver power to the AC power grid, with a power flow as generally suggested by the arrow 86. In some examples where the reconfigurable power system 76 is operating in the mode illustrated in FIG. 9, the first power converter 28 may perform maximum power point tracking with the photovoltaic cells 78.

In the mode illustrated in FIG. 10, the switches 66, 68, 69 are closed, while the switches 62, 64 are open, such that the first power converter 28 of the reconfigurable power system 76 is coupling the plurality of photovoltaic cells 78 and the electrical energy storage device 24 to the AC power grid connection 26, with the electrical energy storage device 24 being coupled to the plurality of photovoltaic cells 78 and to the first power converter 28 by way of the second power converter 29. In this mode, the first power converter 28 is configured to function as a DC-AC inverter such that the photovoltaic cells 78 and the electrical energy storage device 24 both deliver power to the AC power grid, with a power flow as generally suggested by the arrows 88 and with the second power converter 29 discharging the electrical energy storage device 24.

In some examples where the reconfigurable power system 76 is operating in the mode illustrated in FIG. 10, the first power converter 28 may perform maximum power point tracking with the photovoltaic cells 78. The first power converter 28 is able to perform maximum power point tracking for the photovoltaic cells when the reconfigurable power system 76 is operating in the mode illustrated in FIG. 10 because discharging the electrical energy storage device 24 through the second power converter 29 to deliver power to the AC power grid means that the voltage of the photovoltaic cells 78, vₚᵥ, need not be governed by the voltage of the electrical energy storage device 24, V_{bat}.

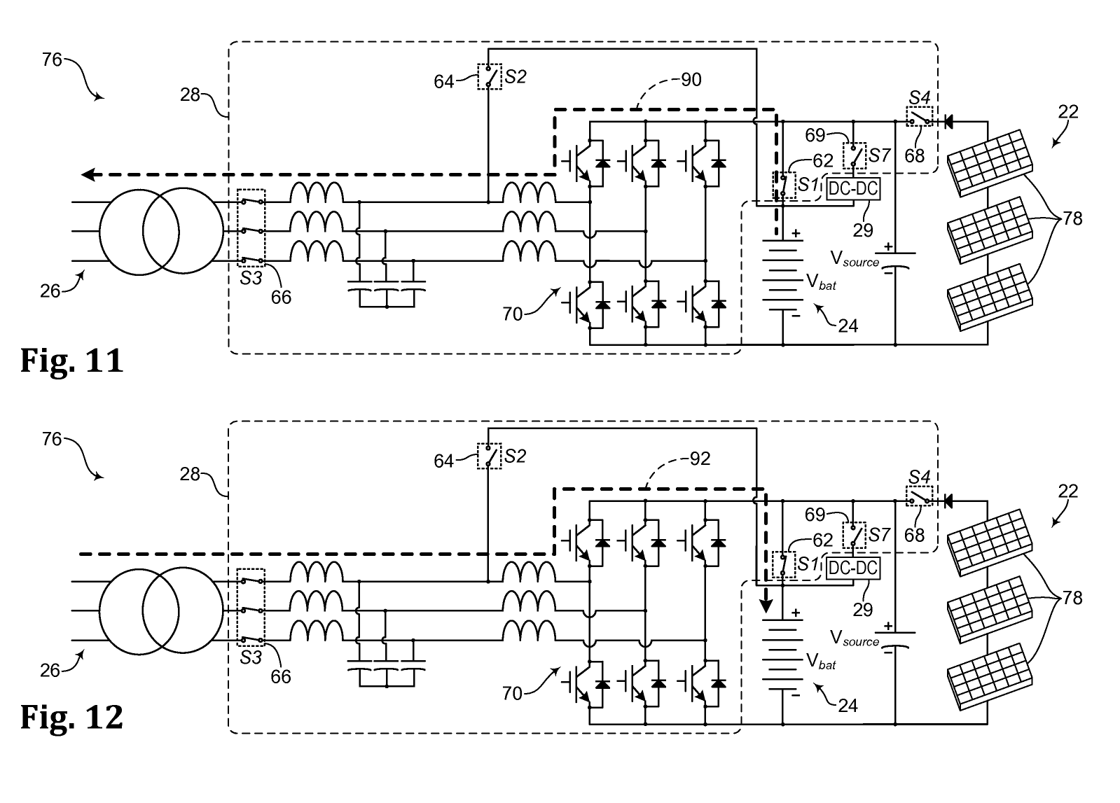

In the mode illustrated in FIG. 11, the switches 62, 66 are closed, while the switches 64, 68, 69 are open, such that the first power converter 28 of the reconfigurable power system 76 is coupling the electrical energy storage device 24 to the AC power grid connection 26. In this mode, the first power converter 28 is configured to function as a DC-AC inverter such that the electrical energy storage device 24 delivers power to the AC power grid, with a power flow as generally suggested by the arrow 90.

In the mode illustrated in FIG. 12, the switches 62, 66 are closed, while the switches 64, 68, 69 are open, such that the first power converter 28 of the reconfigurable power system 76 is coupling the electrical energy storage device 24 to the AC power grid connection 26. In this mode, the first power converter 28 is configured to function as an AC-DC converter such that the electrical energy storage device 24 is charged from the AC power grid, with a power flow as generally suggested by the arrow 92.

In some examples, peak hourly grid load demand and/or peak power consumption may generally occur, between about 4:00 PM (16:00) and about 8:00 PM (20:00). However, peak photovoltaic (PV) power generation may generally occur, for example, between about 11:00 AM (11:00) and about 3:00 PM (15:00). Thus, in some examples, hourly grid load demand may not match well with purely photovoltaic power generation or photovoltaic power generation without electrical energy storage. However, if photovoltaic power generation is combined with electrical energy storage, such as where a power system includes both photovoltaic cells and electrical energy storage devices, a better match to the grid load demand may be realized. In particular, photovoltaic energy generated before the hours of peak grid load demand can be stored in a suitable electrical energy storage device and then used during the hours of peak grid load demand.

The following paragraphs describe nonexclusive illustrative examples of methods for or of operating reconfigurable power systems, such as by selectively coupling two or more of a DC power source, an electrical energy storage device, and an AC power grid connection, using the concepts and components disclosed herein. Although the actions of the disclosed methods may be performed in the order in which they are presented below, it is within the scope of this disclosure for the actions, either alone or in various combinations, to be performed before and/or after any of the other actions.

When used as part of a power system and/or power plant, the reconfigurable power converters and reconfigurable power systems disclosed herein may be used and/or operated in any combination of modes suitable to supply power to the grid load demand at a given time of day. For example, the reconfigurable power system 76 of FIGS. 7-12 may be sequentially operated in the modes illustrated in respective ones of FIGS. 7-12 over the course of a normal day.

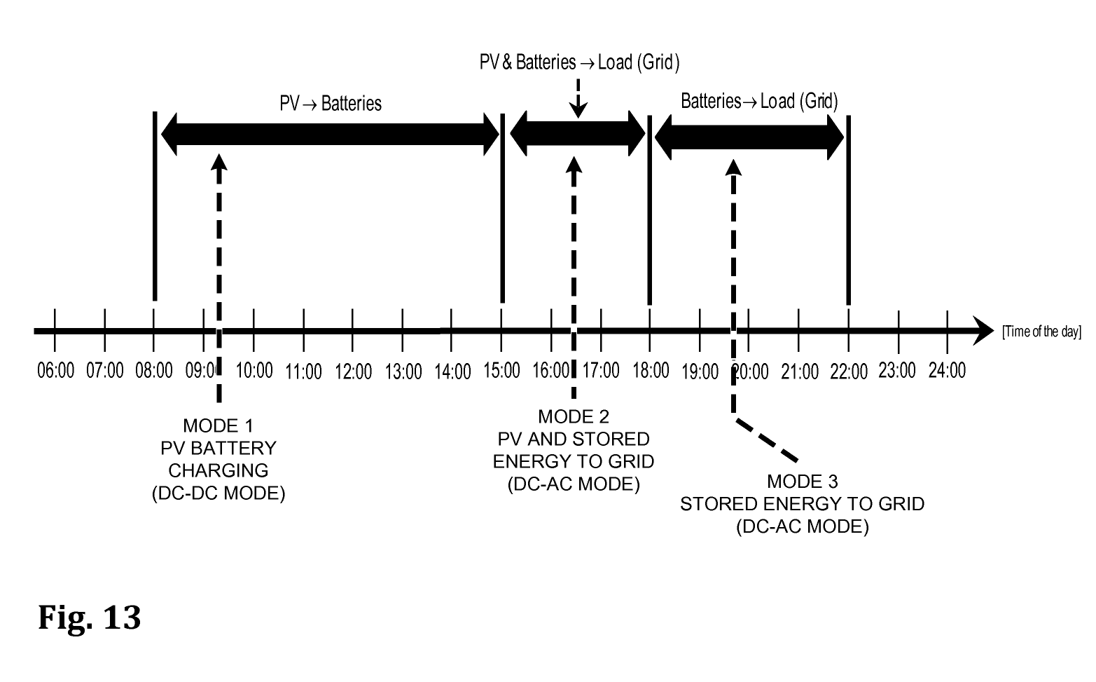

With reference to FIG. 13, a nonexclusive illustrative example of a method of operating a reconfigurable power system may include three sequential modes of operation: MODE 1, MODE 2, and MODE 3. In MODE 1, a first power converter may be configured as a DC-DC converter that couples a DC power source, which may include at least one photovoltaic or solar cell, to an electrical energy storage device to charge the electrical energy storage device, which may include a battery. The reconfigurable power system may be operated in MODE 1 between, for example, about 8:00 AM (08:00) and about 3:00 PM (15:00), which may include the times of day that provide relatively high and/or peak photovoltaic power generation, but are before the hours of peak grid load demand. In MODE 2, the first power converter may be configured as a DC-AC inverter that couples the DC power source to an AC power grid connection, while a second power converter is configured as a DC-DC converter and couples the electrical energy storage device to the DC power source and the first power converter, such that power is delivered to the AC power grid connection from both the DC power source and the energy stored in the electrical energy storage device. The reconfigurable power system may be operated in MODE 2 between, for example, about 3:00 PM (15:00) and about 6:00 PM (18:00), which may include the times of day during which peak grid load demand occurs and during which photovoltaic power generation is still available. In MODE 3, the first power converter may be configured as a DC-AC inverter that couples the electrical energy storage device to the AC power grid connection to deliver stored energy to the AC power grid. The reconfigurable power system may be operated in MODE 3 between, for example, about 6:00 PM (18:00) and about 10:00 PM (22:00), which may include the times of day where photovoltaic power generation may not be available but the grid load demand is still high enough to warrant delivering stored energy from the energy storage device to the AC power grid.

In some examples, the first power converter may perform maximum power point tracking for at least one solar or photovoltaic cell when the first power converter is configured as a DC-DC converter that couples the DC power source to the electrical energy storage device. Thus, in MODE 1, the first power converter may perform maximum power point tracking while charging a battery from a photovoltaic cell.

In some examples, methods of operating reconfigurable power systems may include configuring the first power converter as a DC-AC inverter and coupling the DC power source and/or the electrical energy storage device to the AC power grid therewith, with the second power converter coupling the electrical energy storage device to the DC power source and to the first power converter. In such examples, the first power converter may perform maximum power point tracking for at least one solar or photovoltaic cell when the first power converter is configured as a DC-AC inverter that couples the DC power source and/or the electrical energy storage device to the AC power grid. Thus, in Mode 2 the first power converter may perform maximum power point tracking while delivering power to the AC power grid from both the DC power source and the electrical energy storage device.

In some examples, methods of operating reconfigurable power systems may include configuring the first power converter as an AC-DC converter and coupling the AC power grid to the electrical energy storage device therewith. In such an example, power may be drawn from the AC power grid to charge the electrical energy storage device, such as during hours of low grid load demand.

In some examples, a capacitor may be connected in parallel with the electrical energy storage device. In such examples, the methods of operating reconfigurable power systems, such as when transitioning from the MODE 1 to the MODE 2 discussed above, may include uncoupling the DC power source from the electrical energy storage device, equalizing a voltage of the electrical energy storage device to a voltage of the capacitor, and then configuring the first power converter as a DC-AC inverter and coupling the DC power source and the electrical energy storage device to the AC power grid after equalizing the voltage of the electrical energy storage device to the voltage of the capacitor, with the electrical energy storage device being coupled to the DC power source and the first power converter by way of the second power converter.

Equalizing the voltage of the electrical energy storage device to the voltage of the capacitor may reduce or prevent potentially large inrush currents that may otherwise flow into the electrical energy storage device from the capacitor when the DC power source is connected to the electrical energy storage device, such as during a transition or change from MODE 1 to MODE 2. Reducing or preventing large inrush currents into the electrical energy storage device may reduce or prevent damage to the electrical energy storage device and/or improve its lifetime.

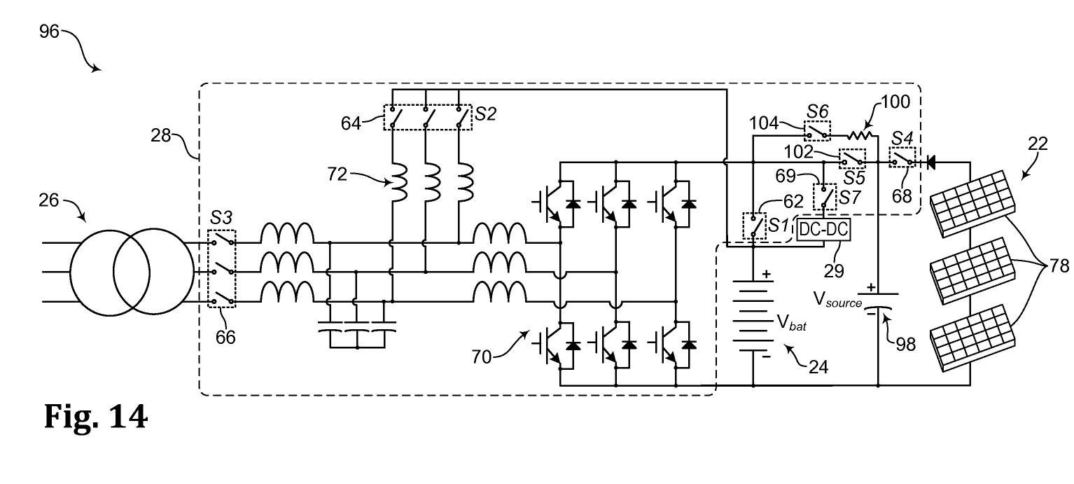

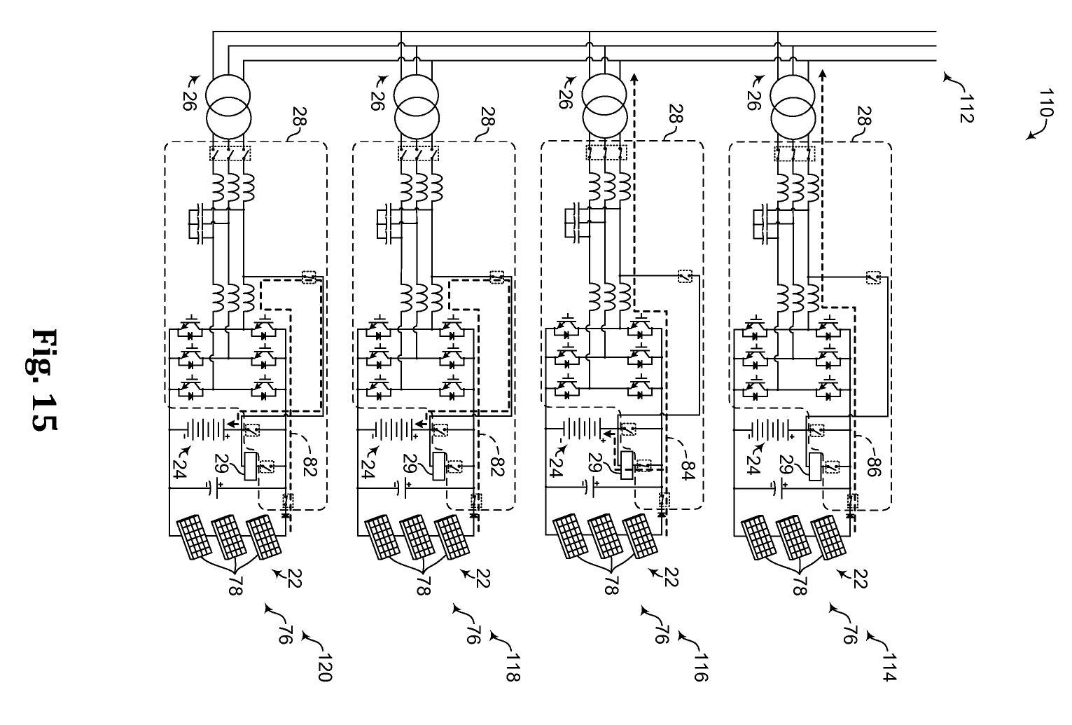

In some examples, equalizing the voltage of the electrical energy storage device to the voltage of the capacitor may include connecting the electrical energy storage device to the capacitor through a current-limiting device, such as a resistor, which may limit the current flowing into the electrical energy storage device until the voltage levels are equalized. Such an example may be further explained with reference to the nonexclusive illustrative example of a reconfigurable power system shown generally at 96 in FIG. 14. Unless otherwise specified, the reconfigurable power system 96 may, but is not required to, contain at least one of the structures, components, functionalities, and/or variations described, illustrated, and/or incorporated herein. As shown, the reconfigurable power system 96 includes a DC power source 22 having a plurality of photovoltaic cells 78, an electrical energy storage device 24 that includes a battery, an AC power grid connection 26, a first power converter 28, a second power converter 29, a capacitor 98 connected in parallel with the electrical energy storage device 24 and the DC power source 22, a resistor 100, and a plurality of switches 62, 64, 66, 68, 69, 102 and 104.

In MODE 1 the power system 96 would be configured similarly to FIG. 7, with the switches 62, 66, 69 open and the switches 64, 68, 102 closed such that the first power converter 28 couples the DC power source 22 to the electrical energy storage device 24. In MODE 2 the power system 96 would be configured similarly to FIG. 10, with the switches 62, 64 open and the switches 66, 68, 69, 102 closed such that the first power converter 28 couples the DC power source 22 and the electrical energy storage device 24 to the AC power grid connection 26, with the electrical energy storage device 24 being coupled to the DC power source 22, the first power converter 28 and the AC power grid connection 26 by way of the second power converter 29. When transitioning the reconfigurable power system 96 from MODE 1 to MODE 2, the switch 102 may be opened and the switch 104 may then be closed to selectively series-couple the electrical energy storage device 24 to the capacitor 98 through the resistor 100 to equalize the voltage, V_{bat}, of the electrical energy storage device 24 to the voltage, vₚᵥ, of the capacitor 98 prior to opening the switch 104 and closing the switches 66, 69, 102 to couple the DC power source 22 and the electrical energy storage device 24 to the AC power grid connection 26, with the switch 64 being opened before closing the switch 66.

When transitioning the reconfigurable power system 96 from the MODE 2 to the MODE 3 discussed above, the switch 102 need only be opened. However, operation of the first power converter 28 and/or its converter circuits 70 may be discontinued while opening the switch 102, which may prevent or reduce transient performance.

A nonexclusive illustrative example of a power plant is shown generally at 110 in FIG. 18. Unless otherwise specified, the power plant 110 may, but is not required to, contain at least one of the structures, components, functionalities, and/or variations described, illustrated, and/or incorporated herein. In the illustrated example, the power plant 110 includes a plurality of reconfigurable power systems 76, which are connected together in parallel and assembled into the power plant 110, and an AC grid connection 112. In the illustrated example, the plurality of reconfigurable power systems 76 includes a first reconfigurable power system 114, a second reconfigurable power system 116, a third reconfigurable power system 118, and a fourth reconfigurable power system 120.

As may be understood, a suitable number of suitable reconfigurable power systems 76 may be assembled into any suitably sized power plant 110. Nonexclusive illustrative examples of suitable sizes for power plant 110 may include 50 KW, 100 KW, 200 KW, 250 KW, 500 KW, or even 1000 KW or larger.

Furthermore, as may be understood, the various reconfigurable power systems 76 within the power plant 110 may be configured into suitable combinations of modes, such as those illustrated in FIGS. 7-12, to more closely match the power delivered from the power plant 110 to the AC grid connection 112.

For example, when the power generated by or available from the DC power sources 22 of the reconfigurable power systems 76 of the power plant 110 is greater than the grid load demand at a particular time, the power plant 110 may be configured such that only the amount of the power requested by the AC power grid is delivered to the AC grid connection 112, with the rest of the power generated by or available from the DC power sources 22 being stored into one or more of the electrical energy storage devices 24. In such an example, at least one of the reconfigurable power systems may be configured to deliver the power generated by its DC power source to the AC power grid, at least one of the reconfigurable power systems may be configured to deliver a portion of the power generated by its DC power source to the AC power grid while storing the remainder of its generated power in its electrical energy storage device, and at least one of the reconfigurable power systems may be configured to store the power generated by its DC power source in its electrical energy storage device.

FIG. 15 illustrates an example where the power plant 110 is configured to store generated power that is in excess of the grid load demand at a particular time. In FIG. 15, the first reconfigurable power system 114 is configured as in FIG. 9, with its first power converter 28 configured as a DC-AC inverter that couples its DC power source 22 to its AC power grid connection 26 to deliver power from its DC power source to its AC power grid connection. In some examples, the first power converter 28 of the first reconfigurable power system 114 may perform maximum power point tracking for the photovoltaic cells 78 of its DC power source. The second reconfigurable power system 116 is configured as in FIG. 8, with its first power converter 28 configured as a DC-AC inverter that couples its DC power source 22 to its electrical energy storage device 24 and to its AC power grid connection 26 to deliver power from its DC power source 22 to the AC power grid and to store energy in its electrical energy storage device. As shown in FIG. 15, the electrical energy storage device 24 of the second reconfigurable power system 116 is coupled to the DC power source and the first power converter of the second reconfigurable power system 116 by way of the second power converter, which allows maximum power point tracking by the first power converter of the second reconfigurable power system 116. The third reconfigurable power system 118 and the fourth reconfigurable power system 120 are configured as in FIG. 7, with their first power converters 28 configured as DC-DC converters that couple their DC power sources 22 to their electrical energy storage devices 24 to store energy therein. In some examples, the first power converters of the third and fourth reconfigurable power system 118, 120 may perform maximum power point tracking for the photovoltaic cells 78 of their DC power sources.

The following paragraphs present a nonexclusive list of examples of how the power plant 110 may be configured to supply power to and/or otherwise interact with an AC power grid.

Where the grid load demand does not warrant delivering power from the DC power sources 22 of the reconfigurable power systems 76 of the power plant 110 to the AC power grid, all of the power generated by the DC power sources 22 may be stored in the electrical energy storage devices 24. In such an example, each of the power plant's reconfigurable power systems 76 may be configured as in FIG. 7, with its first power converter 28 configured as a DC-DC converter that couples its DC power source 22 to its electrical energy storage device 24.

Where the grid load demand equals the power generated by or available from the DC power sources 22 of the reconfigurable power systems 76 of the power plant 110, the power plant 110 may be configured such that all power generated by the DC power sources 22 is delivered to the AC grid connection 112. In such an example, each of the power plant's reconfigurable power systems 76 may be configured as in FIG. 9, with the first power converter 28 configured as a DC-AC inverter that couples its DC power source 22 to its AC grid connection 26.

Where the grid load demand exceeds the power generated by or available from the DC power sources 22 of the reconfigurable power systems 76 of the power plant 110, the power plant 110 may be configured to deliver power to the AC grid connection 112 from at least some of the electrical energy storage devices 24 in addition to the power generated by the DC power sources 22. In such an example, at least some of the power plant's reconfigurable power systems 76 may be configured as in FIG. 10, with the first power converter 28 configured as a DC-AC inverter that couples its DC power source 22 and, by way of its second power converter 29, its electrical energy storage devices 24 to its AC grid connection 26.

When the DC power sources 22 of the reconfigurable power systems 76 of the power plant 110 are unable to supply power, but a grid load demands exists, the power plant 110 may be configured such that the electrical energy storage devices 24 of at least some of the reconfigurable power systems 76 deliver power to the AC grid connection 112. In such an example, at least some of the power plant's reconfigurable power systems 76 may be configured as in FIG. 11, with the first power converter 28 configured as a DC-AC inverter that couples its electrical energy storage devices 24 to its AC power grid connection 26.

When power is available from the AC power grid, at least some of the electrical energy storage devices 24 of the reconfigurable power systems 76 of the power plant 110 may be charged using power drawn from the AC grid connection 112. In such an example, at least some of the power plant's reconfigurable power systems 76 may be configured as in FIG. 12, with the first power converter 28 configured as an AC-DC converter that couples its AC power grid connection 26 to its electrical energy storage devices 24.

The methods disclosed herein may at least partially be embodied as or take the form of the methods described herein, as well as of a transitory or non-transitory computer readable medium having a plurality of machine- or computer-readable instructions stored thereon that, when executed by a processor, carry out operations of the disclosed methods and systems. The computer-readable medium may be any medium that can contain, store, communicate, propagate, or transport program instruction for use by or in connection with the instruction execution system, apparatus, or device and may, by way of example but without limitation, be an electronic, magnetic, optical, electromagnetic, infrared, or semiconductor system, apparatus, device, or propagation medium or other suitable medium upon which the program is recorded. More specific examples (a non-exhaustive list) of such a computer-readable medium may include: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Computer program code or instructions for carrying out operations of the disclosed methods and systems may be written in any suitable programming language provided it allows achieving the previously described technical results. The instructions may be configured for execution on any system, apparatus or device having sufficient processing power and access to any required data.

It is believed that the disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the disclosure includes all novel and non-obvious combinations and subcombinations of the various elements, features, functions and/or properties disclosed herein. Similarly, recitation in the disclosure and/or the claims of “a” or “a first” element, or the equivalent thereof, should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

What is claimed is:

1. A reconfigurable power system, comprising:
a DC power source;
an electrical energy storage device;
an AC power grid connection;
a first power converter configured to selectively couple two or more of the DC power source, the electrical energy storage device, and the AC power grid connection; and
a second power converter configured to selectively couple the electrical energy storage device to at least one of the DC power source and the first power converter, wherein the second power converter is configured as a DC-DC converter.

2. The reconfigurable power system of claim 1, wherein the DC power source includes at least one photovoltaic cell, and the first power converter is configured to perform maximum power point tracking for the at least one photovoltaic cell when coupling the DC power source to at least one of the electrical energy storage device and the AC power grid connection.

3. The reconfigurable power system of claim 1, wherein the electrical energy storage device includes a battery.

4. The reconfigurable power system of claim 1, wherein at least one of the first and second power converters includes at least one semiconductor switching device.

5. The reconfigurable power system of claim 1, wherein the first power converter is configured to selectively function as a DC-AC inverter, a DC-DC converter, or an AC-DC converter.

6. The reconfigurable power system of claim 5, wherein, when the first power converter couples the DC power source and the electrical energy storage device to the AC power grid connection, the first power converter is configured to function as the DC-AC inverter and the second power converter couples the electrical energy storage device to the DC power source and the first power converter.

7. The reconfigurable power system of claim 5, wherein the first power converter is configured to function as the DC-DC converter when coupling the DC power source to the electrical energy storage device to charge the electrical energy storage device.

8. The reconfigurable power system of claim 5, wherein the first power converter is configured to function as the AC-DC converter when coupling the AC power grid connection to the electrical energy storage device to charge the electrical energy storage device.

9. The reconfigurable power system of claim 1, wherein:
the reconfigurable power system is configured to operate in a selected one of at least three modes;
in a first one of the modes the first power converter is configured as a DC-DC converter coupling the DC power source to the electrical energy storage device;
in a second one of the modes the first power converter is configured as a DC-AC inverter coupling the DC power source and the electrical energy storage device to the AC power grid connection and the second power converter couples the electrical energy storage device to the DC power source and the first power converter; and
in a third one of the modes the first power converter is configured as an AC-DC converter coupling the AC power grid connection to the electrical energy storage device.

10. The reconfigurable power system of claim 1, wherein:
the reconfigurable power system is configured to operate in a selected one of at least three modes;
in a first one of the modes the first power converter is configured as a DC-DC converter coupling the DC power source to the electrical energy storage device;
in a second one of the modes the first power converter is configured as a DC-AC inverter coupling the DC power source and the electrical energy storage device to the AC power grid connection and the second power converter couples the electrical energy storage device to the DC power source and the first power converter; and
in a third one of the modes the first power converter is configured as a DC-AC inverter coupling the electrical energy storage device to the AC power grid connection.

11. The reconfigurable power system of claim 10, where in a fourth one of the at least three modes the first power converter is configured as a DC-AC inverter coupling the DC power source to the AC power grid connection.

12. The reconfigurable power system of claim 10, comprising:
a capacitor connected in parallel with the electrical energy storage device and the DC power source; and
a resistor configured to selectively series-couple the electrical energy storage device to the capacitor.

13. The reconfigurable power system of claim 1 assembled into a power plant, the power plant comprising a plurality of the reconfigurable power systems connected together.

14. The power plant of claim 13, wherein:
the plurality of the reconfigurable power systems comprises a first reconfigurable power system and a second reconfigurable power system;
in the first reconfigurable power system, the first power converter of the first reconfigurable power system is selectively configured as a DC-DC converter that couples the DC power source of the first reconfigurable power system to the electrical energy storage device of the first reconfigurable power system; and
in the second reconfigurable power system, the first power converter of the second reconfigurable power system is selectively configured as a DC-AC inverter that couples the AC power grid connection of the second reconfigurable power system to at least one of the DC power source of the second reconfigurable power system and the electrical energy storage device of the second reconfigurable power system.

15. The power plant of claim 14, wherein in the second reconfigurable power system, the second power converter of the second reconfigurable power system couples the electrical energy storage device of the second reconfigurable power system to at least one of the DC power source of the second reconfigurable power system and the first power converter of the second reconfigurable power system.

16. A reconfigurable power converter, comprising:
a power source connection configured to couple with a DC power source;
a storage device connection configured to couple with an electrical energy storage device;
a grid connection configured to couple with an AC power grid;
a first power converter configured to selectively couple two or more of the power source connection, the storage device connection, and the grid connection, wherein the first power converter is selectively configured as one of:
a DC-DC converter when coupling the power source connection to the storage device connection;
a DC-AC inverter when coupling at least one of the power source connection and the storage device connection to the grid connection; and
an AC-DC converter when coupling the grid connection to the storage device connection; and
a second power converter configured to selectively couple the storage device connection to at least one of the power source connection and the first power converter, wherein the second power converter is configured as a DC-DC converter.

17. The reconfigurable power converter of claim 16, wherein the DC power source includes at least one photovoltaic cell, and the first power converter is configured to perform maximum power point tracking for the at least one photovoltaic cell when coupling the power source connection to at least one of the storage device connection and the grid connection.

18. The reconfigurable power converter of claim 16, wherein the electrical energy storage device includes a battery.

19. The reconfigurable power converter of claim 16, wherein at least one of the first and second power converters includes at least one semiconductor switching device.

20. The reconfigurable power converter of claim 16, comprising a resistor configured to selectively limit inrush current to an electrical energy storage device coupled with the storage device connection.

21. A method of operating a reconfigurable power system comprising a DC power source, an electrical energy storage device, and an AC power grid connection, the method comprising:
configuring a first power converter as a DC-DC converter and coupling the DC power source to the electrical energy storage device therewith;
configuring the first power converter as a DC-AC inverter and coupling the DC power source to the AC power grid connection therewith while a second power converter couples the electrical energy storage device to the DC power source and the first power converter, wherein the second power converter is configured as a DC-DC converter; and
configuring the first power converter as a DC-AC inverter and coupling the electrical energy storage device to the AC power grid connection therewith.

22. The method of claim 21, wherein the DC power source includes at least one solar cell, and the first power converter is configured to perform maximum power point tracking for the at least one solar cell when coupling the DC power source to the electrical energy storage device and the AC power grid connection.

23. The method of claim 21, comprising configuring the first power converter as an AC-DC converter and coupling the AC power grid connection to the electrical energy storage device.

24. The method of claim 21, wherein a capacitor is connected in parallel with the electrical energy storage device, and the method comprises:
uncoupling the DC power source from the electrical energy storage device;
equalizing a voltage of the electrical energy storage device to a voltage of the capacitor; and
configuring the first power converter as a DC-AC inverter and coupling the DC power source and the electrical energy storage device to the AC power grid connection after equalizing the voltage of the electrical energy storage device to the voltage of the capacitor, wherein the electrical energy storage device is coupled to the DC power source and the first power converter by way of the second power converter.

25. The method of claim 24, wherein equalizing the voltage of the electrical energy storage device to the voltage of the capacitor comprises connecting the electrical energy storage device to the capacitor through a resistor.
